(19) United States
(12) Patent Application Publication
(10) Pub. No.: US 2025/0346489 A1
(43) Pub. Date: Nov. 13, 2025

(54) THERMALLY DRIVEN NITROGEN AND AMMONIA PRODUCTION

(71) Applicants: National Technology & Engineering Solutions of Sandia, LLC, Albuquerque, NM (US); Arizona Board of Regents on behalf of Arizona State University, Scottsdale, AZ (US)

(72) Inventors: Andrea Ambrosini, Albuquerque, NM (US); James E. Miller, Albuquerque, NM (US); Ellen B. Stechel, Albuquerque, NM (US)

(21) Appl. No.: 19/276,116

(22) Filed: Jul. 22, 2025

Related U.S. Application Data
(62) Division of application No. 17/127,444, filed on Dec. 18, 2020.
(60) Provisional application No. 62/950,197, filed on Dec. 19, 2019.

(51) Int. Cl. C01B 21/04; C01B 21/02; C01C 1/02

(52) U.S. Cl. CPC C01B 21/0422; C01B 21/02; C01C 1/026

(57) ABSTRACT

The present disclosure is directed to renewable pathways to nitrogen production and ammonia (NH₃) synthesis that utilize renewable heat as process heat instead of fossil fuels and operates at low to medium pressures (from 0.2-3 MPa). The renewable pathways result in both a decrease or elimination of greenhouse gas emissions as well as avoid the cost, complexity and safety issues inherent in high-pressure processes. Renewable thermochemical looping technology is used that produces nitrogen from air for the subsequent production of ammonia via an advanced two-stage process.

### CROSS-REFERENCE TO RELATED APPLICATIONS

This application is a divisional of U.S. Ser. No. 17/127,444, entitled “THERMALLY DRIVEN NITROGEN AND AMMONIA PRODUCTION,” filed Dec. 18, 2020, which claims priority to provisional patent applications U.S. Ser. No. 62/950,197, entitled “SOLAR THERMOCHEMICAL AMMONIA PRODUCTION,” by Ambrosini et al., filed Dec. 19, 2019, both disclosures of which are incorporated herein by reference in their entireties.

### STATEMENT OF GOVERNMENT INTEREST

The United States Government has rights in this invention pursuant to Contract No. DE-NA0003525 between the United State Department of Energy and National Technology & Engineering Solutions of Sandia, LLC, both for the operation of the Sandia National Laboratories.

### FIELD

The present disclosure is generally directed to thermally-driven chemical processes and more particularly to chemical processes driven by renewable thermal energy to produce nitrogen and ammonia.

### BACKGROUND

Ammonia (NH₃) is an energy-dense chemical and is vital to modern agriculture as a source of fixed nitrogen for fertilizers, its primary use. In addition, it is an important industrial chemical and intermediate, a refrigerant, a potential candidate for thermochemical energy storage for high-temperature concentrating solar power (CSP), and a potential liquid carrier for hydrogen delivery. If manufactured with renewable energy sources, it can serve as a carbon-neutral liquid fuel. Currently, NH₃ synthesis is accomplished via the Haber-Bosch (HB) process, which requires high pressures (15-25 MPa) and medium to high temperatures (400-500° C.). Nitrogen (N₂) and hydrogen (H₂) are essential HB feedstocks. The H₂ is generally derived from methane via steam reforming and water gas shift which yields CO₂ as a co-product; N₂ is sourced by adding air to the gas mixture, with oxygen (O₂) removal via combustion of methane to CO₂ and water. CO₂ and water are removed in a scrubber, leaving a mixture of H₂ and N₂ to be pressurized and converted to ammonia. Thus, in HB, both basic feedstocks contribute to the creation and release of CO₂ into the environment. In addition, hydrocarbon fuels are a primary source of the auxiliary energy provided to the process, e.g. for compression, further increasing CO₂ emissions. As a result, HB ammonia synthesis processes account for almost 2% of world-wide CO₂ emissions.

Utilizing concentrating solar to renewably synthesize NH₃ via steam hydrolysis of metal nitrides (MN), such as AlN, to produce NH₃ has been performed. Solar-thermal hydrolytic reaction of metal nitrides to produce NH₃ has also been reported. In the hydrolysis reaction, MN reacts with steam to form a metal oxide (MO) and NH₃. The MN is regenerated by heating in the presence of N₂ and a carbon source (carbothermal reduction). As such it produces CO₂ as a byproduct. Additionally, while these reactions can be conducted at low pressures, carbothermal regeneration often requires temperatures up to 1500° C., requiring special materials and complex reactor designs.

A variation on this approach entailing the direct nitridation of metals, such as Cr, Mo, and Zn, has also been reported. In this case, the initial hydrolysis step is the same as above, but the MO is first carbo-thermally reduced completely to zero-valent metal, and then subsequently reacted with N₂ to form the MN. While this process may result in more facile MN synthesis, it still requires high temperatures and, in some cases, the added complication of dealing with metal vapor.

Another set of alternatives to HB is the electrochemical synthesis of NH₃, including aqueous systems utilizing Nafion membranes, solid state electrolytic systems, and molten salt systems. While the electrochemical approach has been proven feasible, challenges include selectivity, deactivation of the electrodes, and the need for expensive catalysts.

Thus, what is needed are ammonia production systems and processes that overcome these and other deficiencies.

### SUMMARY OF THE DISCLOSURE

The present disclosure is directed to a system for producing nitrogen that includes a reduction reactor comprising a heat source, a nitrogen production reactor, and a mass of metal oxide within the reduction reactor. The mass of metal oxide is heated by the heat source and reduced in the reduction reactor to produce a mass of reduced metal oxide, and the mass of reduced metal oxide is oxidized in the nitrogen production reactor with air to produce an enriched nitrogen stream or oxidized with a similar oxygen-containing gas to deplete the oxygen from the stream.

The present disclosure is further directed to a system for producing ammonia that includes a nitrogen production sub-system that includes a reduction reactor comprising a heat source, a nitrogen production reactor and a mass of metal oxide within the reduction reactor. The mass of metal oxide is heated by the heat source and reduced in the reduction reactor to produce a mass of reduced metal oxide, and the mass of reduced metal oxide is oxidized in the nitrogen production reactor by air to produce nitrogen. The system further includes an ammonia production sub-system that includes an ammonia production reactor, a nitridation reactor, and a mass of metal nitride in the ammonia production reactor. The mass of metal nitride is reacted with hydrogen in the ammonia production reactor to produce a mass of nitrogen-deficient metal nitride and ammonia, and the mass of nitrogen-deficient metal nitride is reacted with nitrogen produced in the nitrogen production sub-system to form the mass of metal nitride.

The present disclosure is further directed to a method for producing nitrogen that includes the following steps:
a) reducing a metal oxide by heating the metal oxide to produce a reduced metal oxide;
b) oxidizing the reduced metal oxide in the presence of air or other gas containing oxygen and nitrogen to produce the metal oxide and nitrogen;
c) using the metal oxide produced in step b) in step a); and
d) discharging the nitrogen produced in step b) for further use.

The present disclosure is further directed to a method for producing nitrogen that includes the following steps:
a) reducing a metal oxide by heating the metal oxide with solar irradiance to produce a reduced metal oxide and oxygen;
b) oxidizing the reduced metal oxide in the presence of a fluid comprising oxygen and nitrogen to produce the metal oxide and an enriched nitrogen stream;
c) using the metal oxide produced in step b) in step a); and
d) discharging the nitrogen produced in step b) to a nitridation reactor;
e) nitriding nitrogen-depleted metal nitride with the nitrogen in the nitridation reactor to produce metal nitride; and
f) reacting the metal nitride with hydrogen in an ammonia production reactor to produce ammonia and the nitrogen depleted metal nitride of step e); and
g) discharging the ammonia from the ammonia production reactor.

An advantage of the disclosure are systems and processes that reduce fossil energy needed to produce ammonia, reduce feedstock requirements, and reduce environmental impact.

An advantage of the disclosure is production of ammonia at significantly lower pressures than the Haber-Bosch process.

Alternative exemplary embodiments relate to other features and combinations of features as may be generally recited in the claims.

### BRIEF DESCRIPTION OF THE DRAWINGS

FIG. 1 illustrates a N₂ recovery and NH₃ production system and process according to an embodiment of the disclosure.

### DETAILED DESCRIPTION OF THE DISCLOSURE

Before turning to the discussion and FIGURE which illustrates the exemplary embodiments in detail, it should be understood that the application is not limited to the details or methodology set forth in the following description or illustrated in the FIGURE. It should also be understood that the phraseology and terminology employed herein is for the purpose of description only and should not be regarded as limiting.

The present disclosure is directed at systems and processes that use renewable pathways to synthesize nitrogen (N₂) and ammonia (NH₃) that utilize concentrated solar irradiation to provide process heat in place of fossil fuels and operate under low or ambient pressures to produce nitrogen. Other renewable sources of heat or energy could also be employed to drive primary and auxiliary systems. The systems and processes decrease or eliminate traditional greenhouse gas emissions associated with past systems and processes, and avoid the cost, complexity, and safety issues inherent in very high-pressure processes. The systems and processes utilize thermochemical looping to produce and shuttle N₂ from air for the subsequent production of ammonia via a novel advanced two-stage process.

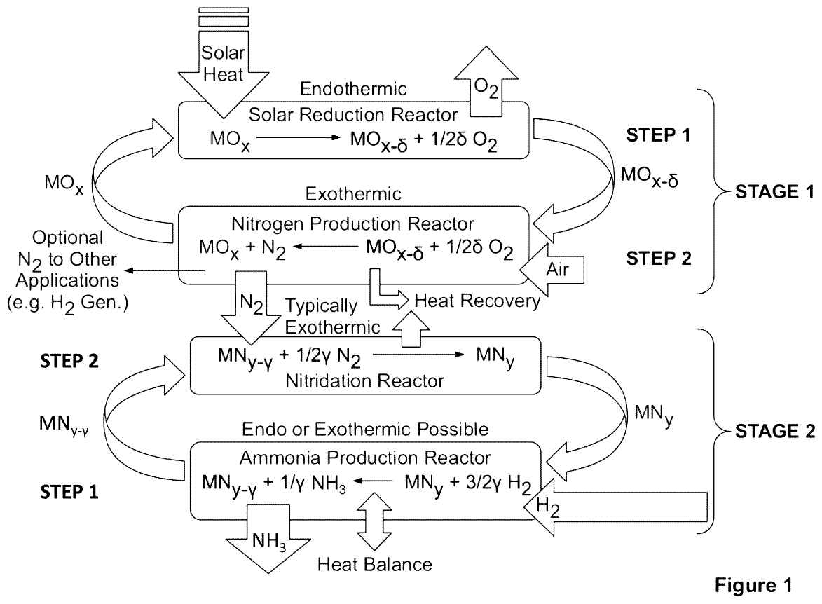

FIG. 1 illustrates an embodiment of a nitrogen and ammonia production process according the disclosure. As can be seen in FIG. 1, the process includes two stages, each with two steps. In Stage 1, thermochemical looping depletes O₂ from air or a nitrogen/oxygen containing stream to produce substantially pure N₂ that can be discharged from the stage as a substantially pure N₂ stream for a subsequent process or processes. In subsequent Stage 2, the N₂ produced from Stage 1 is used to produce ammonia via an advanced two-step thermochemical process, and the ammonia can be discharged from the stage as a substantially pure ammonia stream. In other embodiments, excess N₂ produced in Stage 1 may be used in other processes. For example, N₂ may be used as a sweep or purge gas or as an inert gas blanket in such processes as thermochemical water or carbon dioxide splitting, thermochemical energy storage, chemical and materials manufacturing, food preservation and storage, safe handling applications and storage of flammable compounds.

As can be seen in FIG. 1, Stage 1 includes two steps that may be referred to collectively as thermochemical looping. In Stage 1, Step 1, an endothermic reaction of a metal oxide is performed by heating the material of stoichiometry MQO to a reduction temperature to yield a reduced metal oxide M_{α}O_{1-δ} and gaseous oxygen (O₂). In some embodiments, the reduction may be aided or enhanced through the use of a reduced pressure through vacuum pumping or a gas sweep. The produced oxygen is removed from the reduction reactor and may be used for other purposes, such as, but not limited to, nitrogen-free combustion to enhance carbon capture, industrial or chemical processing, medical use, etc.

In Stage 1, Step 2, air or a gaseous fluid containing oxygen and nitrogen is brought into contact with the reduced metal oxide. The oxidation of the reduced metal oxide scavenges oxygen from the air or mixture, resulting in a nitrogen or nitrogen-rich gas stream, restores the metal oxide to its initial state, and produces heat. In some embodiments, this step may be further sub-divided into primary and polishing steps to enhance efficiency and improve gas purity. In a primary step, ≥90% of the oxygen is removed from the air; the polishing step then removes the remainder to meet the targeted gas specification. The primary and polishing steps may optionally employ different metal oxides or other materials or processes. In some embodiments, a non-thermochemical primary step, such as pressure-swing adsorption, could be utilized to decrease initial oxygen concentration or to remove unwanted minor air components before the thermochemical polishing step. The produced heat from this step may be recovered and used for other purposes, such as, but not limited to, preheating of the air stream for Stage 1, Step 2. In another embodiment, the produced heat may be used to preheat the gas stream in the nitridation reactor, Stage 2, Step 2, since that process requires lower temperatures. The regenerated metal oxide is returned to Stage 1, Step 1.

Stage 1, Step 1 is performed in a reduction reactor. In an embodiment, the heat for reduction, Stage 1, Step 1, may be provided directly or indirectly via concentrated solar irradiance, such as in a concentrated solar technology (CST) system as is known in the art. In this embodiment, the reduction reactor may be referred to as a solar reduction reactor. In an embodiment, the CST system may be a falling particle solar receiver or a solar moving bed particle receiver. In other embodiments, the metal oxide may be in the form of a monolith or other structured body. The high temperature particle reduction zone may be referred to as a solar reduction reactor. The reduced particles are provided to a lower temperature nitrogen production reactor or zone, Stage 1, Step 2, where the reduced metal oxides react with oxygen to regenerate the metal oxide and produce nitrogen. The re-oxidized metal oxide is recirculates to the reduction reactor or zone of Stage 1, Step 1. In an embodiment, the metal oxide is recirculated by a belt or bucket conveyor, screw conveyor or elevator, pneumatic conveyor, or other material transport mechanism. In an embodiment, the nitrogen production reactor is arranged so that the flowing reduced metal oxide contacts air in a counter-current fashion. In other embodiments, the reduced metal oxide may be stored and used for nitrogen production at a later time.

In other embodiments, heat could be provided to the reduction reactor by another renewable source (CST being a renewable resource), such as combustion of biomass, biogas, animal waste, resistance heating from renewable electric sources such as photovoltaic (PV), wind, or by non-renewable sources.

The metal oxide used in the nitrogen production step, Stage 1, is a metal oxide that is capable of removing oxygen from air in its reduced state, leaving a stream that is substantially oxygen-free nitrogen with other minor air components. In an embodiment, the metal oxide is composed of redox-active transition metals, such as, but not limited to Mn, Co, Fe, V, W, Mo, Cr and Cu. In an embodiment the metal oxide compound may be, but not limited to Co₃O₄/CoO and MnO/Mn₃O₄/Mn₂O₃/MnO₂.

In another embodiment, the metal oxide is a mixed ionic and electronic conducting oxide (MIEC). In an embodiment the MIEC is as those found in the fluorite- and perovskite-related families. These MIECs are under the general term of metal oxides in this disclosure. MIECs offer superior reaction kinetics and added entropy drivers, although their redox capacity can be limited. In an embodiment, the materials are selected to maximize oxygen capacity and minimize the reduction endotherm via cation substitution to tune performance. Key materials properties to consider include reaction thermodynamics, i.e. redox capacity or state as a function of temperature and O₂ partial pressure, reaction kinetics, reaction endotherm and exotherm, heat capacities, intraparticle heat and mass transfer rates, cycle-to-cycle repeatability, and chemical and physical stability. These considerations apply to both the reduction step and the re-oxidation, i.e. the N₂-producing, step. In an embodiment, the metal oxide(s) used are the product of balancing materials (energy requirements) and systems (integration with the heat source, operability, toxicity, availability, and cost) considerations to achieve the best value.

In an embodiment, the MIEC may have the formula:
AₓA′₁₋ₓB_{y}B′_{1-y}O_{3-δ}, where A=La, Sr, Ca, Ba, Y and B=Mn, Fe, Co, Ti, Ni, Cu, Zr, Al, Y, Cr, V, Nb, Mo, and 0≤x≤1, 0≤y≤1 and 0≤δ≤1.

In an embodiment, Aₓ=Ba, La, A′₁₋ₓ=Sr, B_{y}=Cr, Cu, Co, Mn, and B′_{y-1}=Fe.

In an embodiment, the non-MIEC may be Fe₃O₄/FeO, MnO/Mn₃O₄/Mn₂O₃/MnO₂, Co₃O₄/CoO, Cu₂O/CuO/CuO₂/Cu₂O₃, VO/V₂O₃/VO₂/V₂O₅, MoO₂/MoO₃, Cr₂O₃/CrO₃, W₂O₃/WO₂/WO₃/W₂O₅, or various mixtures or combinations of these compounds with one another and other metallic or non-metallic elements to form new compounds with desirable properties.

The metal oxide may be in the form of a particulate or structured material. The structure may be, but is not limited to spheres or other geometrical shapes, or structured packings such as saddles, hollow or porous spheres, corrugated materials, lattice or mesh structures, honeycomb or other channel structures, etc. For example, the metal oxide may be in the form of particles or particulates in a CSP falling particle system or fluidized bed system. In another example, the metal oxide may be a monolithic channeled or corrugated structure or packing of geometric structures, e.g. porous beads, situated in the interior of a tubular reactor/solar receiver system.

The reduction step, Stage 1, Step 1, takes place at least at the reduction temperature and pressure of the selected metal oxide. In an embodiment, the temperature may be 400-1200° C. In another embodiment, the temperature may be 600-1000° C. In an embodiment, the pressure may be 1.0×10⁻⁷ to 0.1 MPa total absolute, 1.0×10⁻⁷ to 2.1×10−2 MPa pO₂. In another embodiment, the pressure may be 1.0×10⁻⁴ to 0.1 MPa total, 1.0×10⁻⁴ to 2.1×10−2 MPa pO₂.

The nitrogen production step, Stage 1, Step 2, takes place at the oxidation temperature and pressure of the selected metal oxide. In an embodiment, the temperature may be 200-1000° C. In another embodiment, the temperature may be 400-700° C. In an embodiment, the pressure may be 1×10⁻² to 0.1 MPa total absolute, 1.0×10⁻⁵ to 2.1×10−2 MPa pO₂. In another embodiment, the pressure may be 0.1 MPa total, 1.0×10⁻³ to 2.1×10−2 MPa pO₂.

As discussed above, Stage 1, Step 1, reduction, may be performed in a CSP reactor where the CSP reactor is a solar reduction reactor. In this case, Stage 1, Step 2, nitrogen production may be performed in a separate nitrogen production reactor, for example a fluidized bed reactor. In other embodiments, the Stage 1, Step 1 reactor may be a fluidized bed or other suitable reactor. In other embodiments, the Stage 1, Step 1, and Stage 1, Step 2 reactors may be the same reactor that is alternated between Steps 1 and 2. For example, if the chosen reactor is of the packed tube variety the reduction maybe carried out by exposing the tube to concentrated solar flux under vacuum or a small amount of inert flow, and then taken “off sun”, allowed to cool or forcibly cooled, and then exposed to a flowing stream of air, or in the case of a polishing or similar situation, exposed to a gas stream containing oxygen in excess of the equilibrium oxygen partial pressure over the reduced solid.

In other embodiments, the system and methodology of Stage 1 can be used to remove oxygen from any input steam containing oxygen and other constituents to produce and oxygen depleted and other constituent rich product steam. In an embodiment, an input steam of an inert gas and oxygen can be input to remove oxygen and produce a pure inert gas product stream.

Referring again to FIG. 1, the nitrogen produced in Stage 1 is used for Stage 2 ammonia production. The nitrogen may be provided by any suitable fluid conduit. As can be seen in FIG. 1, a portion of the produced nitrogen is optionally exported to other applications, such as, but not limited to hydrogen generation.

In Stage 2, Step 1, a metal nitride (M_{β}N), is reacted with hydrogen (H₂) to produce nitride-deficient metal nitride (M_{β}N_{1-γ}) and ammonia (NH₃). Note that nitride-deficient metal nitride may be referred to as a “reduced” metal nitride. The term “heat balance” as used in FIG. 1 means the reaction can be either endothermic (or at least metastable) or exothermic (preferred), depending on the energy required or released to achieve the re-nitridation in Stage 2, Step 2.

The nitrogen-deficient metal nitride is then passed to Stage 2, Step 2 where the nitrogen from Stage 1 is introduced into a nitridation reactor containing the nitrogen-deficient metal nitride (M_{β}N_{1-γ}). The nitrogen reacts to restore the nitrogen deficiency, referred to as “nitridation”. That is, the reaction increases the formal oxidation state of the metal (the metal is formally reduced, i.e. becomes more positive). The reaction may be either moderately endo- or exothermic.

In an embodiment, the ammonia production and nitridation reactors may be counter-flow moving bed particle reactors. Alternately, the reactions may be carried out in a fluidized bed reactor, in batch or semi-batch mode, a falling particle reactor, a short-contact-time reactor, or any other system commonly known to the art. In an embodiment the ammonia production and nitridation reactor may be the same reactor that is cycled between steps.

The ammonia production step, Stage 2, Step 1, occurs at 100-800° C. In an embodiment, the ammonia production step occurs at 200-500° C. The pressure for Stage 2, Step 1 is between 0.1-15 MPa. In an embodiment, the pressure is between 0.2-3 MPa.

The nitridation step, Stage 2, Step 2, occurs at 200-1000° C. In an embodiment, the nitridation step occurs at 200-500° C. The pressure for Stage 2, Step 1 is between 0.1-5 MPa. In an embodiment, the pressure is between 0.1-2 MPa.

The metal nitride is a material capable of reacting with hydrogen to produce ammonia. The nitrides will be composed of nitrogen and other elements with systematic variations in composition. The composition and makeup are chosen to impact key performance metrics, specifically the temperatures and rates of N₂ uptake and release, and the NH₃ yield and selectivity. Elements that are excessively toxic, rare, radioactive or otherwise judges unsuitable are generally excluded from consideration for the bulk of the nitride composition. However the possibility of using small amounts of elements in these categories to fine-tune properties is not excluded.

In an embodiment, the metal nitride may include metallic and transition metal elements, including, but not limited to Mn, Mo, Co, Sr, Ca, Mg, Fe, Ni, and Zn, which are combined to form complex (multi-metal) materials with systematic variations in composition. In an embodiment, the metal nitride may include metallic and transition metal elements and certain non-metals or semi-metals. These materials affect key performance metrics, specifically the temperatures and rates of N₂ uptake and release, and the NH₃ yield and selectivity.

In an embodiment, the metal nitride may include redox active metallic and transition metal elements, including, but not limited to Cr, Fe, Mn, Mo, V, W, Co, Cu, Ge, and Ni, and non-redox active metals including Ba, Ga, Li, Mg, Na, Sr, Sn and Zn. In an embodiment, the metal nitride may contain certain non-metals including but not limited to P, B, Si, S, and C.

Metal nitride combinations of particular interest are identified as combinations that form stable and meta-stable nitrides and then applying screening criteria including the formation energies (enthalpies) relative to that of ammonia. In an embodiment, the metal combinations to form nitrides include Co—Mn, Co—Mo, Co—W, Cu—Ba, Cu—Li, Cu—Mg, Cu—Sr, Ge—Cr, Ge—Fe, Fe—Mo, Ge—Mn, Ge—Na, Ni—Fe, Ni—Mn, Ni—Mo, Ni—W, Ni—Na, Ni—Sr, Sn—Cr, Sn—Mn, Zn—Cr, Zn—Mn, and Zn—Mo. In an embodiment, the metal nitride may be a ternary or quaternary compounds formed by any combination of the above metal nitrides, such as, but not limited to Co—Fe—Mo (Co—Mo+Fe—Mo) and Co—Mo—Fe—Ni (Co—Mo+Fe—Mo+Ni—Mo). Additional elements may also be included to further fine-tune the properties.

In an embodiment, the metal nitride is formed of two redox active metals. In an embodiment, the redox active metal nitride may be

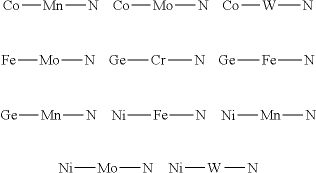

In an embodiment, the metal nitride may be Co—Mo—N, and the formulation may be, but is not limited to Co₃Mo₃N, CoMo₄N₅, Co₂Mo₃N, Co₂Mo₄N.

In an embodiment, the metal nitride is formed of a non-redox active metal (listed first) and a redox active metal (listed second). In an embodiment, the overall redox active metal nitride may be, but is not limited to:

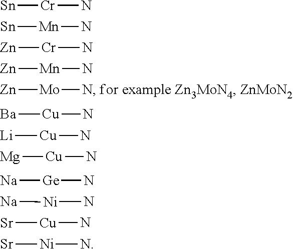

In an embodiment, the metal nitride may include in small amounts of additional elements as modifiers, promoters, or catalysts. In an embodiment, the additional elements may be alkali and/or noble metals. Small amounts are defined as quantities less than 10% of the total. Additionally, materials may be included to manipulate and maintain the size and shape of the materials and micro and macro porosity, such as inert ceramic carriers or binders. In an embodiment, the additional materials may be alumina, silica, titania, and/or magnesia.

In an embodiment, the metal nitride may be doped or substituted with another element, e.g., M′_{y}M_{1-y}N, where M′ can be a metal and 0>y>1. These dopants or substituents are similar and analogous to the doping or substituting materials in the oxide discussion above.

In the above processes of Stage 1 and 2, each stage is a redox pair consisting of two steps; for Stage 1, one reaction is endothermic and other equivalently exothermic. For Stage 2, both the reactions may be a combination of endo- and exothermic, or both exothermic, and sum to be exothermic overall. The equations can be written as:

$$Stage 1 , Step 1 : \frac{1}{4 δ} {M}_{α} O \to \frac{1}{4 δ} {M}_{α} {O}_{1 - δ} + \frac{1}{8} {O}_{2} \qquad Eq . 1 a$$

$$Stage 1 , Step 2 : \frac{5}{8} Air + \frac{1}{4 δ} {M}_{α} {O}_{1 - δ} \to \frac{1}{4 δ} {M}_{α} O + \frac{1}{2} {N}_{2} Where \frac{5}{8} Air \approx \frac{1}{2} {N}_{2} + \frac{1}{8} {O}_{2} , \qquad Eq . 1 b$$

$$Stage 2 , Step 1 : \frac{3}{2} {H}_{2} + \frac{1}{γ} {M}_{β} N \to {NH}_{3} + \frac{1}{γ} {M}_{β} {N}_{1 - γ} \qquad Eq . 2 a$$

$$Stage 2 , Step 2 : \frac{1}{2} {N}_{2} + \frac{1}{γ} {M}_{β} {N}_{1 - γ} \to \frac{1}{γ} {M}_{β} N \qquad Eq . 2 b$$

In the first reaction (Eq. 1a), concentrated solar irradiation drives the endothermic reduction of the redox-active metal oxide; subsequent exposure to air (Eq. 1b) in appropriate stoichiometric ratios, at a lower temperature causes the material to re-oxidize, removing O₂ from the air to levels defined by the thermodynamic equilibrium, thereby producing a stream that is predominantly N₂ gas and that is nearly oxygen-free. In an embodiment, the reduction of the redox-active metal oxide particles may be in a counter-current flow arrangement with a sweep gas to facilitate transport and thermodynamics.

In other embodiments, other oxygen and nitrogen-containing fluids may be used in place of air. By tuning the operating conditions and the material, N₂ can be produced at the desired purity level. Separation by redox cycling can also use multiple oxide materials of differing reduction enthalpy, or a single material with different temperature swings between reduction and oxidation, to stage the purification and minimize the total thermal input while also minimizing the residual oxygen content. Other conventional polishing steps, e.g. chemical getters, may also be employed to fine-tune the residual oxygen content. Heat demand can be decreased by recuperating heat between the reduction and oxidation reactions or using the heat in other parts of the system. That is, the heat removed when cooling the reduced solid can be used to reheat the oxidized solid being returned to the reduction reactor or that heat can be used for other purposes. The processes can be repeated indefinitely in a cyclic fashion. It requires little to no conversion of thermal energy to electrical energy and requires no pressurization of air; i.e. residual power demands are relatively small.

The second reaction pair (Eq. 2a, 2b) accomplishes NH₃ synthesis and regeneration of the nitrogen carrier working material. These reactions are ideally performed at low pressures relative to HB. First, the nitride is reduced by H₂ (typically with excess H₂ reactant relative to available nitrogen in the nitride), extracting some nitrogen from the lattice and directly producing NH₃ (Eq. 2a). Second, the nitrogen-deficient nitride reacts with the purified N₂ from Stage 1, regenerating the nitride. Note that no reaction in the set requires pressures as high as Haber-Bosch, and likely much lower, and there is no direct coupling of the two Stages (nitrogen separation and ammonia synthesis/re-nitridation). Hence, by appropriately sizing the two processes, N₂ can effectively be stored in solid form (i.e., the nitride) and be provided on-demand to match H₂ production rates. This also minimizes the need to store N₂ or any gas in a compressed form. Additionally, or alternately, N₂-generating capacity for 24-hour, around the clock production is feasible by storing metal oxide from the oxygen separation step in its reduced form, which can produce on-demand N₂ via re-oxidation. In an embodiment, the oxygen-depleted air can potentially provide a reducing environment to facilitate a water-splitting process for H₂ generation. In an embodiment, nitrogen can be “stored” indefinitely in the re-nitrided material and used to produce ammonia on demand. In an embodiment, the reduced metal oxide can be stored until it is required to produce nitrogen. Both embodiments can allow around-the-clock operation, even when not on sun.

The produced ammonia may be removed and used for other applications, such as, but not limited to fertilizer, e.g. ammonium nitrate or urea, industrial chemical and intermediates, refrigerant, a potential candidate for thermochemical energy storage for high-temperature concentrating solar power (CSP), thermochemical energy storage on the grid generally, a carbon-neutral liquid fuel, or a hydrogen carrier to transport hydrogen for energy or for chemical production.

The invention being thus described, it will be obvious that the same may be varied in many ways. Such variations are not to be regarded as a departure from the spirit and scope of the invention, and all such modifications as would be obvious to one skilled in the art are intended to be included within the scope of the appended claims. It is intended that the scope of the invention be defined by the claims appended hereto. The entire disclosures of all references, applications, patents, and publications cited above are hereby incorporated by reference.

In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A system for producing ammonia, comprising:
a nitrogen production sub-system, comprising:
a reduction reactor comprising a heat source;
a nitrogen production reactor; and
a mass of metal oxide within the reduction reactor;
wherein the mass of metal oxide is heated by the heat source and reduced in the reduction reactor to produce a mass of reduced metal oxide; and
wherein the mass of reduced metal oxide is oxidized in the nitrogen production reactor in the presence of an input stream comprising oxygen and nitrogen to remove the oxygen and produce a nitrogen enriched product stream; and
an ammonia production subsystem, comprising:
an ammonia production reactor;
a nitridation reactor; and
a mass of metal nitride in the ammonia production reactor;
wherein the mass of metal nitride is reacted with hydrogen in the ammonia production reactor to produce a mass of nitrogen-deficient metal nitride and ammonia; and
wherein the mass of nitrogen-deficient metal nitride is reacted with the nitrogen product stream produced in the nitrogen production sub-system to form the mass of metal nitride.

2. The system of claim 1, wherein the heat source concentrated solar energy.

3. The system of claim 1, wherein the reduction reactor is the solar heating zone of the falling particle solar receiver.

4. The system of claim 1, wherein the input stream is air.

5. The system of claim 1, wherein the metal nitride is a redox active metal or transition metal nitride.

6. The system of claim 1, wherein the metal nitride comprises metals selected from the groups consisting of redox active metals including Cr, Fe, Mn, Mo, V, W, Co, Cu, Ge, and Ni, and non-redox active metals including Ba, Ga, Li, Mg, Na, Sr, Sn and Zn.

7. The system of claim 1 wherein the metal nitride further comprises one or more elements selected from the group consisting of P, B, Si, S and C.

8. The system of claim 1, wherein the metal nitride is selected from the group consisting of Co—Mn, Co—Mo, Co—W, Cu—Ba, Cu—Li, Cu—Mg, Cu—Sr, Ge—Cr, Ge—Fe, Ge—Mn, Ge—Na, Ni—Fe, Ni—Mn, Ni—Mo, Ni—W, Ni—Na, Ni—Sr, Sn—Cr, Sn—Mn, Zn—Cr, Zn—Mn, and Zn—Mo.

9. A method for producing nitrogen, comprising:
a) reducing a metal oxide by heating the metal oxide to produce a reduced metal oxide;
b) oxidizing the reduced metal oxide in the presence of an input stream comprising oxygen and nitrogen to remove the oxygen and produce the metal oxide and a nitrogen product stream;
c) using the metal oxide produced in step b) in step a); and
d) discharging the nitrogen produced in step b) for further use.

10. The method of claim 9, wherein the heating is by concentrated solar energy.

11. The method of claim 9, wherein the input stream is air.

12. The method of claim 9, wherein the metal oxide is selected from the group of oxides of Mn, Co, Fe, V, W, Mo, Cr and Cu.

13. The method of claim 9, wherein the metal oxide is a mixed ionic and electronic conducting oxide is a selected from the group having the formula AₓA′₁₋ₓB_{y}B′_{1-y}O_{3-δ}, where A=La, Sr, Ca, Ba, Y and B=Mn, Fe, Co, Ti, Ni, Cu, Zr, Al, Y, Cr, V, Nb, Mo, and 0≤x≤1, 0≤y≤1 and 0≤δ≤1.

14. A method for producing ammonia, comprising:
a) reducing a metal oxide by heating the metal oxide with solar irradiance to produce a reduced metal oxide and oxygen;
b) oxidizing the reduced metal oxide in the presence of an input stream comprising oxygen and nitrogen to remove the oxygen and produce the metal oxide and an enriched nitrogen product stream;
c) using the metal oxide produced in step b) in step a); and
d) discharging the nitrogen produced in step b) to a nitridation reactor;
e) nitriding nitrogen-depleted metal nitride with the nitrogen in the nitridation reactor to produce metal nitride; and
f) reacting the metal nitride with hydrogen in an ammonia production reactor to produce ammonia and the nitrogen depleted metal nitride of step e); and
g) discharging the ammonia from the ammonia production reactor.

15. The method of claim 14, wherein the heating is by concentrated solar energy.

16. The system of claim 14, wherein the metal nitride is a redox active metal or transition metal nitride.

17. The method of claim 14, wherein the input stream is air.

18. The system of claim 14, wherein the metal nitride comprises metals selected from the groups consisting of redox active metals including Cr, Fe, Mn, Mo, V, W, Co, Cu, Ge, and Ni, and non-redox active metals including Ba, Ga, Li, Mg, Na, Sr, Sn and Zn.

19. The system of claim 14, wherein the metal nitride further comprises one or more elements selected from the group consisting of P, B, Si, S and C.

20. The system of claim 14, wherein the metal nitride is selected from the group consisting of Co—Mn, Co—Mo, Co—W, Cu—Ba, Cu—Li, Cu—Mg, Cu—Sr, Ge—Cr, Ge—Fe, Ge—Mn, Ge—Na, Ni—Fe, Ni—Mn, Ni—Mo, Ni—W, Ni—Na, Ni—Sr, Sn—Cr, Sn—Mn, Zn—Cr, Zn—Mn, and Zn—Mo.

21. A system for producing an oxygen depleted product stream, comprising:
a reduction reactor comprising a heat source;
an oxidation reactor; and
a mass of metal oxide within the reduction reactor;
wherein the mass of metal oxide is heated by the heat source and reduced in the reduction reactor to produce a mass of reduced metal oxide; and
wherein the mass of reduced metal oxide is oxidized in the oxidation reactor in the presence of an input stream comprising oxygen and one or more other gasses to produce the product stream enriched in the one or more other gasses.

22. The system of claim 21, wherein the heat source is concentrated solar energy.

23. The system of claim 21, wherein the reduction reactor is the solar heating zone of the falling particle solar receiver or other receiver configurations.

24. The system of claim 21, wherein the one or more other gases are one or more inert gases.

25. The system of claim 21, wherein the mass of metal oxide is a mass of metal oxide particles or a metal oxide structed material.

26. The system of claim 21, wherein the metal oxide is selected from the group consisting of oxides of Mn, Co, Fe, V, W, Mo, Cr and Cu.

27. The system of claim 21, wherein the metal oxide is a mixed ionic and electronic conducting oxide selected from the group of metal oxides having the formula AₓA′₁₋ₓB_{y}B′_{1-y}O_{3-δ}, where A=La, Sr, Ca, Ba, Y and B=Mn, Fe, Co, Ti, Ni, Cu, Zr, Al, Y, Cr, V, Nb, Mo, and 0≤x≤1, 0≤y≤1 and 0≤δ≤1.

28. A method for producing an enriched product stream, comprising:
e) reducing a metal oxide by heating the metal oxide to produce a reduced metal oxide;
f) oxidizing the reduced metal oxide in the presence of an input gas stream comprising oxygen and other gases to remove the oxygen and produce the metal oxide and an enriched product stream depleted of oxygen and enriched in the other gases;
g) using the metal oxide produced in step b) in step a); and
h) discharging the enriched stream produced in step b) for further use.

29. The method of claim 28, wherein the heating is by concentrated solar energy.

30. The method of claim 28, wherein the other gases are one or more inert gases.

31. The method of claim 28, wherein the metal oxide is selected from the group of oxides of Mn, Co, Fe, V, W, Mo, Cr and Cu.

32. The method of claim 28, wherein the metal oxide is a mixed ionic and electronic conducting oxide is a selected from the group having the formula AₓA′₁₋ₓB_{y}B′_{1-y}O_{3-ι}, where A=La, Sr, Ca, Ba, Y and B=Mn, Fe, Co, Ti, Ni, Cu, Zr, Al, Y, Cr, V, Nb, Mo, and 0≤x≤1, 0≤y≤1 and 0≤δ≤1.
